(19) United States
(12) Patent Application Publication
(10) Pub. No.: US 2010/0045023 A1
(43) Pub. Date: Feb. 25, 2010

(54) METHOD FOR APPLYING A METAL ELEMENT TO A SECURITY DOCUMENT

(75) Inventor: Harald Deinhammer, Wien (AT)

Correspondence Address: HENRY M FEIEREISEN, LLC;HENRY M FEIEREISEN, 708 THIRD AVENUE, SUITE 1501, NEW YORK, NY, 10017, US

(73) Assignee: Oesterreichische Banknoten- und Sicherheitsdruck Gmbh, Wien (AT)

(21) Appl. No.: 11/814,048

(22) PCT Filed: Jan. 16, 2006
(86) PCT No.: PCT/AT2006/000017

§ 371 Date: Jul. 16, 2007

(30) Foreign Application Priority Data
Jan. 17, 2005 (AT) A 63/2005

(51) Int. Cl. B42D 15/10; B31F 1/07

(52) U.S. Cl. 283/72; 101/32

(57) ABSTRACT

The invention relates to a method for applying a metal element to a security document using a stamp element, the metal element being configured from a metal layer of foil and being applied to the security document, preferably in a hot embossing process. To increase the protection against forgery, during the application of the metal element (2), the latter (2) is embossed (21) by means of a stamping surface (31) of the stamp element (3), which is configured as a line gravure printing plate (32).

The invention relates to a method for applying a metal element to a security document using a stamp element, with the metal element being configured from a metal layer of foil and being applied to the security document, preferably in a hot embossing process.

It is known from WO 02/20274 A1 to apply a metal foil to a security document and to apply in a subsequent step an embossing in a line gravure printing process. The disadvantageous aspect is that especially by deformations of the security document during the line gravure printing process it may occur that there will be register imprecision. It is proposed in WO 02/20274 A1 to mask such register imprecision by colored areas.

It is the object of the present invention to provide a method of the kind mentioned above in which the known disadvantages are avoided and which allows achieving a high amount of security against forgery.

This is achieved in accordance with the invention in such a way that during the application of the metal element, the latter is embossed by means of a stamping surface of the stamp element, which is configured as a line gravure printing plate.

The advantage in this method is that any subsequent line gravure printing process can be performed independent from the embossing of the metal element and no precautions are required for register imprecision in the position of the metal element. If a subsequent line gravure printing process is not provided, the embossing of the metal element can be achieved in an especially simple way by means of the method in accordance with the invention. The register precision of the embossing on the metal element represents an additional security feature which can be checked easily and offers a high amount of security against forgery.

The invention further relates to a security document with a metal element which can be produced in accordance with one of the methods described above.

It is known from WO 02/20274 A1, in the case of a security document with an applied metal foil, to apply an embossing in line gravure printing on the same, with register imprecision being masked by colored sections.

It is the object of the present invention to provide a security document of the kind mentioned above which avoids the known disadvantages and offers a high amount of security against forgery.

This is achieved in accordance with the invention in such a way that the metal element has an embossing with precise register.

The register precision of the embossing on the metal element represents an additional security feature which can be checked easily and offers a high amount of security against forgery.

It can be provided in a further development of the invention that the embossing has a precision of less than 25 μm, especially less than 10 μm.

The security against forgery can be improved even further by observing this high precision which can be reproduced only with a high amount of effort.

The invention further relates to a stamp element for the method mentioned above.

It is a further object of the invention to provide a stamp element with which the method as mentioned above can be carried out easily and quickly.

This is achieved in accordance with the invention in that the stamp surface is arranged as a line gravure printing plate.

The advantageous aspect is that the embossing of the metal element can occur during the application on the security document. A possibly subsequent line gravure printing process can be carried out independent of the embossing of the metal element and precautions for register imprecision of the position of the metal element are not necessary.

According to a further embodiment of the invention it can be provided that the line gravure printing plate is made of hard brass and/or a hard brass alloy. This choice of material ensures a high endurance of the stamp element. Furthermore, the stamp can be produced with the required precision with the method in accordance with the invention.

The invention further relates to a method for producing a stamp element as described above.

It is a further object of the invention to provide a method of the kind mentioned above with which the stamp element can be produced easily and quickly.

This is achieved in accordance with the invention in such a way that a laser is used to introduce recesses and/or lines in a stamp surface arranged as a line gravure printing plate made of hard brass and/or a hard brass alloy.

This leads to the advantage that the stamp surface has the required strength. The stability can be increased even further especially by chromium plating. Moreover, fine structures can be introduced into the stamp surface with the laser. The precision of these structures can be improved even further by an aftertreatment for removing melt fins. A further advantage is that the depth of the lines can be chosen independent from each other, thus enabling an increase in the security of the security documents produced with the stamp element.

It can be provided in a further development of the invention that melt fins are removed after the introduction of recesses and/or lines. The precision of the lines and/or recesses can be increased considerably, thus improving reproducibility of the stamp element and its resolution.

In this context it may be provided for in accordance with a further embodiment of the invention that the melt fins are removed by means of a chemical aftertreatment, especially an acid bath, an electrolytic bath or the like. The melt fins can be removed easily and quickly with a chemical aftertreatment. Only the copper oxide or the zinc oxide of the melt fins is removed in a purposeful manner, but not the material of the stamp surface.

According to a further embodiment of the invention it can be provided that the acid bath comprises acetic acid, phosphoric acid and nitric acid, especially approximately 40% by volume of acetic acid, 50% by volume of phosphoric acid and 10% by volume of nitric acid. In this composition of the acid bath, a mirroring and plane surface of the stamp surface can be achieved after an immersing treatment of a few minutes, with further aftertreatment steps not being necessary.

In a further embodiment of the invention it can be provided that the depth for each of the recesses and/or lines and/or for a group of recesses and/or lines is predetermined independent from each other. By choosing a different depth of the recesses and/or lines, it is possible to form an additional security feature, thus further increasing the security from forgery of security documents produced with the stamp element. It can further be ensured in other embodiments of the stamp element in accordance with the invention that all recesses and/or lines substantially have the same depth, which thus ensures an especially uniform embossing.

The invention is now explained in closer detail by reference to the enclosed drawings which show embodiments, wherein:

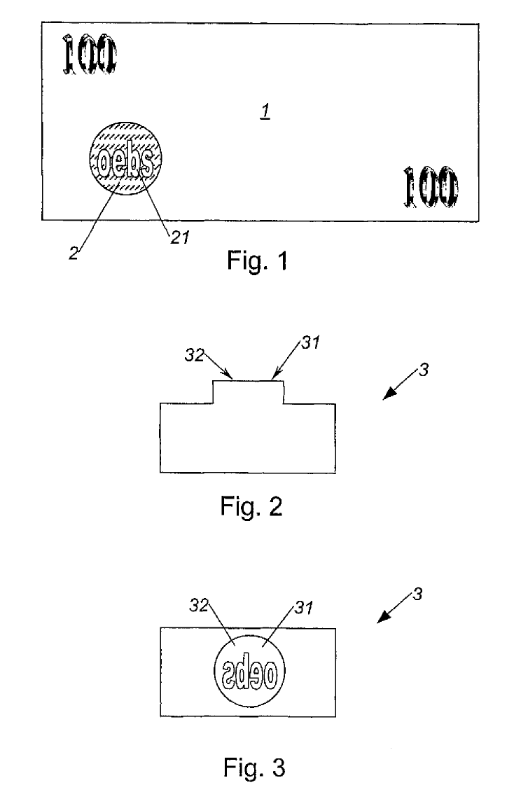

FIG. 1 shows a top view of a security document in accordance with the invention;

FIG. 2 shows a side view of a stamp element in accordance with the invention;

FIG. 3 shows a top view of the stamp element in accordance with FIG. 2.

FIG. 1 shows a security document 1 in accordance with the invention, comprising a metal element 2, with the metal element 2 having an embossing 21 which is precise with respect to register.

The security document 1 is usually provided with a plurality of security elements which should help in recognizing a forgery of the security document 1. One of such security elements can be the applied metal element 2. As a result of the embossing 21 with precise register, an additional security feature is formed which can be checked easily. It is especially advantageous in this respect that imprecision in the position can be recognized very precisely with the naked eye. That is why this additional security element helps in recognizing a forgery by the general public without any additional auxiliary means.

In the case of forgeries, an embossing 21 is often indicated by a print. Since such a print occurs separate from the application of the metal foil, the achievement of a precise register is technically very complex and virtually impossible. In the case of a new security document 1, the tactile embossing 21 can easily be distinguished from a print by touching. In the case of a security document 1 that is used frequently such as a banknote, the embossing 21 is often difficult to detect by touching. The recognition of the register precision can also be detected easily in these security documents 1.

The embossing 21 preferably has a precision of less than 25 μm, especially less than 10 μm. This precision which is usually demanded for banknotes can only be achieved with difficulty by forgers, as a result of which the embossing 21 has a high amount of security from forging. The metal element 2 can further be provided with holographic or other diffractive structures, thus further increasing the security of the security document 1.

This high precision can be achieved with line gravure printing, with which very high pressures are used to form the embossing 21.

The security document 1 in accordance with the invention can be produced in a simple way such that the metal element 2 is applied to the security document 1 with a stamp element 3, with the metal element 2 being formed from the metal layer of a foil. This can occur especially in a hot embossing process with a stamp element 3 shown in FIGS. 2 and 3, with the embossing 21 being applied to the metal element 2 during the application of the metal element 2 by means of a stamp surface 31 of the stamp element 3 arranged as a line gravure printing plate 32. An additional process step for applying the embossing 21 as is provided for in the state of the art is not required. The embossing 21 can be arranged as a blind stamping.

In the hot embossing process, a carrier foil is usually used, to which is applied a release lacquer, a metal layer thereon and an adhesive layer thereon. The carrier foil is applied to the security document 1 as a continuous ribbon. By contact with the hot stamp element 3, the release lacquer and the adhesive layer are locally molten and the metal element 2 is transferred to the security document 1 by pressure. The carrier foil remains intact during this process, with the metal element 2 being applied to the security document 1 from the metal layer in the form of the stamp surface 31.

The stamp element 3 for the production of the security document 1 comprises a stamp surface 31 arranged as a line gravure printing plate 32. An embossing 21 can be achieved with a precision as described above when the line gravure printing plate 32 is made of hard brass and/or a hard brass alloy according to a preferred embodiment.

In the production of the stamp element 3, recesses and/or lines can be introduced with a laser into the stamp surface 31 which is arranged as a line gravure printing plate 32 and is made of hard brass and/or a hard brass alloy. In order to ensure a suitable strength of the printing plate it appears to be appropriate when the hard brass and/or the hard brass alloy has a Vickers hardness of more than 140.

A solid-state basic mode laser, preferably a diode-pumped Nd:YAG laser, can be used as a laser.

As a result of its beam profile, the laser beam penetrates the material surface in a conical way. Melting processes occur in the boundary region of the focused beam which make a portion of the material solidify into undesirable spittings and splashes. The type and size of the spittings at the edge depend on the material, the pulse power and the gravure depth. The laser can be used to engrave metal, ceramic and a number of plastic materials, with the power density of the laser beam being so high that the material partly evaporates during machining within a few nanoseconds. A recess which is colorless in itself is obtained, which is the gravure. Oxides are frequently formed by the interaction of the molten basic material with atmospheric oxygen, which oxides make the gravure stand out more clearly as a result of their color.

The precision of the recesses and/or lines can be improved when the melt fins are removed which are obtained during the introduction of the recesses and/or lines into the line gravure printing plate 32. Said melt fins substantially consist of oxidized material of the line gravure printing plate 32, especially of copper oxide or zinc oxide.

A chemical aftertreatment seems to be especially suitable for removing the melt fins, which may especially comprise an acid bath, electrolytic bath or the like. It can be ensured that the copper oxide or the zinc oxide is removed by the chemical aftertreatment, but not the hard brass and/or hard brass alloy of the line gravure printing plate 32.

The chemical aftertreatment can occur especially by immersion of the line gravure printing plate 32 into an acid bath or the like which comprises phosphoric acid, acetic acid, nitric acid, arsenic acid or the like, or a combination of said acids. An acid bath seems to be especially advantageous which comprises acetic acid, phosphoric acid and nitric acid. The acid bath may especially comprise 40% by volume of acetic acid, 50% by volume of phosphoric acid and 10% by volume of nitric acid. Any undesirable removal of the basic material of the line gravure printing plate 32 can be effectively prevented with such an acid.

After the introduction of the recesses and/or lines and optionally after the removal of the melt fins there can further be a retouching and/or check of the line gravure printing plate 32 in order to enable the recognition and correction of any existing bad spots. In a preferred embodiment of the method in accordance with the invention, the depth of the recesses and/or lines is predetermined in addition to the contour of the recesses and/or lines. This can occur for each recess and/or line individually or jointly for a group of recesses and/or lines. The predetermined values for the individual depths are independent of each other. Different depths can be achieved in the method in accordance with the invention in a simple way by regulating the output of the laser beam or by lasing several times.

1.-10. (canceled)

11. A method for applying a metal element to a security document, comprising the steps of:
a) forming a metal element from a metal layer of a foil;
b) applying the metal element onto a security document; and
c) applying an embossing to the metal element during step b) by means of a stamping surface of a stamp element, with the stamping surface configured as a line gravure printing plate.

12. The method of claim 11, wherein step b) includes a hot embossing process.

13. The method of claim 11, wherein the embossing is an embossing with precise register.

14. The method of claim 11, wherein the embossing has a precision of less than 25 μm.

15. The method of claim 11, wherein the embossing has a precision of less than 10 μm.

16. The method of claim 11, wherein the line gravure printing plate is made of at least a material selected from the group consisting of hard brass and hard brass alloy.

17. The method of claim 11, wherein the step c) includes the step of introducing recesses and/or lines in the stamping surface by a laser.

18. The method of claim 17, further comprising the step of removing melt fins after the introduction of the recesses and/or lines.

19. The method of claim 18, wherein the removing step includes a chemical aftertreatment.

20. The method of claim 19, wherein the chemical aftertreatment includes a treatment in an acid bath or an electrolytic bath.

21. The method of claim 20, wherein the acid bath comprises acetic acid, phosphoric acid and nitric acid.

22. The method of claim 20, wherein the acid bath comprises approximately 40% by volume of acetic acid, 50% by volume of phosphoric acid and 10% by volume of nitric acid.

23. A security document, comprising a metal element having an embossing with precise register having a precision of less than 25 μm.

24. The security document of claim 23, wherein the embossing with precise register has a precision of less than 10 μm.
